(19) United States
(12) Patent Application Publication
(10) Pub. No.: US 2005/0056796 A1
(43) Pub. Date: Mar. 17, 2005

(54) Photo-interrupter and manufacturing method thereof

(76) Inventor: Teruo Takeuchi, Kitakyushu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/910,636

(22) Filed: Aug. 4, 2004

(30) Foreign Application Priority Data
Aug. 8, 2003 (JP) 2003-290634

(51) Int. Cl. G02B 27/00

(52) U.S. Cl. 250/551

(57) ABSTRACT

A photo-interrupter includes a light-emitting-side internal device provided with a light-emitting chip and formed by molding, and a light-receiving-side internal device provided with a light-receiving chip and formed by molding. The light-emitting-side internal device has a light output face, and the light-receiving-side internal device has a light input face. The light-emitting-side internal device and the light-receiving-side internal device are held by a casing, such that the light output face and the light input face are opposite to each other with a gap interposed therebetween. The light output face and the light input face are respectively disposed in first and second slits formed in the casing. The light output face and the light input face are respectively flush with surfaces of the casing around the first and second slits.

### CROSS-REFERENCE TO RELATED APPLICATIONS

This application is based upon and claims the benefit of priority from prior Japanese Patent Application No. 2003-290634, filed Aug. 8, 2003, the entire contents of which are incorporated herein by reference.

### BACKGROUND OF THE INVENTION

1. Field of the Invention

The present invention relates to a photo-interrupter and a manufacturing method of a photo-interrupter.

2. Description of the Related Art

A photo-interrupter includes a light-emitting device and a light-receiving device, which are arranged to detect an object passing through the gap between them, based on change in an optical signal. In accordance with this principle, a photo-interrupter can be used as part of a sensor for detecting the position of an object in a non-contact manner. In recent years, sensors of the photo-interrupter type are widely used in printers, DSCs (Digital Still Camera), and so forth.

FIG. 6 is a perspective view showing a conventional photo-interrupter. As shown in FIG. 6, a light-emitting-side internal device 11 and a light-receiving-side internal device 12 are held by a casing 14 to face each other with a predetermined gap 13 interposed therebetween. The light-emitting-side internal device 11 includes a light-emitting chip mounted on and connected to a lead frame, and a sealing resin layer formed by molding to seal the light-emitting chip. The light-receiving-side internal device 12 includes a light-receiving chip mounted on and connected to a lead frame, and a sealing resin layer formed by molding to seal the light-receiving chip.

The casing 14 consists of an integral body made of a thermo-plastic resin, which is formed by molding. The casing 14 has upright portions on the light-emitting side and light-receiving side, into which the light-emitting-side internal device 11 and light-receiving-side internal device 12 are inserted, respectively. Each of the upright portions on the light-emitting side and light-receiving side of the casing 14 is provided with a slit 15, which forms light guides. The slit 15 has a longitudinal direction perpendicular to the mounting face of the casing 14.

FIG. 7 is a perspective view showing a portion on the light-receiving side of another conventional photo-interrupter. This photo-interrupter has a casing 14 provided with a slit 16, which has a longitudinal direction parallel with the mounting face of the casing 14. As for the rest, the photo-interrupter shown in FIG. 7 is the same as the photo-interrupter shown in FIG. 6. The shape and size of the slits 15 and 16 are arbitrarily set in accordance with conditions, such as required sensitivity.

FIG. 8 is a sectional view showing part of a mold used in a method of manufacturing the photo-interrupter shown in FIG. 7, the view corresponding to the site where an internal device on the light-emitting side or light-receiving side is placed. As shown in FIG. 8, this mold 17 includes first and second portions 17a and 17b between which a bore 17c is defined to form the body of the casing 14. The slit 16 of the casing 14 is formed at a position 17d where the first and second portions 17a and 17b are in contact with each other. The site of the mold 17 where the other internal device is placed has a mirror image of the site shown in FIG. 8 with respect to the centerline therebetween.

FIG. 9 is a sectional side view showing a still another conventional photo-interrupter. In FIG. 9, an optical signal emitted from the light-emitting chip 11a of a light-emitting-side internal device 11 is outputted from a light output face 11d, and passes through a slit 151. The light thus outputted goes across a gap 13, and passes through a slit 152 on the opposite side. Then, the light is inputted into the light input face 12d of a light-receiving-side internal device 12, and is received by a light-receiving chip 12a. In this state, if an object passes through the gap 13, the optical signal received by the light-receiving chip 12a changes. In accordance with this principle, the photo-interrupter can be used as part of a sensor for detecting the position of an object in a non-contact manner.

### BRIEF SUMMARY OF THE INVENTION

According to a first aspect of the present invention, there is provided a photo-interrupter comprising:

a light-emitting-side internal device provided with a light-emitting chip and formed by molding, the light-emitting-side internal device having a light output face;

a light-receiving-side internal device provided with a light-receiving chip and formed by molding, the light-receiving-side internal device having a light input face; and

a casing that holds the light-emitting-side internal device and the light-receiving-side internal device such that the light output face and the light input face are opposite to each other with a gap interposed therebetween, the light output face and the light input face are respectively disposed in first and second slits formed in the casing, and the light output face and the light input face are respectively flush with surfaces of the casing around the first and second slits.

According to a second aspect of the present invention, there is provided a method of manufacturing a photo-interrupter, the method comprising:

mounting and connecting a light-emitting chip and a light-receiving chip onto respective lead frames;

performing molding on the light-emitting chip and the light-receiving chip connected to the lead frames, to form a light-emitting-side internal device and a light-receiving-side internal device, such that the light-emitting-side internal device has a light output face, and the light-receiving-side internal device has a light input face; and

attaching the light-emitting-side internal device and the light-receiving-side internal device to a casing such that the light output face and the light input face are opposite to each other with a gap interposed therebetween, the light output face and the light input face are respectively disposed in first and second slits formed in the casing, and the light output face and the light input face are respectively flush with surfaces of the casing around the first and second slits.

According to a third aspect of the present invention, there is provided a photo-interrupter comprising:

a first internal device including a light-emitting chip, a first lead connected to the light-emitting chip, and a first sealing resin layer sealing the light-emitting chip and a light output face;

a second internal device including a light-receiving chip, a second lead connected to the light-receiving chip, and a second sealing resin layer sealing the light-receiving chip and having a light input face; and

a holder holding the first and second internal devices such that the light output face and the light input face are opposite to each other with a gap interposed therebetween, the holder includes first and second resin walls in which the first and second sealing resin layers of the first and second internal devices are respectively embedded, the light output face is exposed from a first opening formed in the first resin wall and is planarly aligned with a surface of the first resin wall around the first opening, and the light input face is exposed from a second opening formed in the second resin wall and is planarly aligned with a surface of the second resin wall around the second opening.

According to a fourth aspect of the present invention, there is provided a method of manufacturing a photo-interrupter, the method comprising:

electrically connecting a light-emitting chip and a light-receiving chip to first and second leads, respectively;

performing molding on the light-emitting chip and the light-receiving chip respectively connected to the first and second leads, to form first and second internal devices, such that the first internal device includes a first sealing resin layer sealing the light-emitting chip and having a light output face, and the second internal device includes a second sealing resin layer sealing the light-receiving chip and having a light input face; and

forming a holder holding the first and second internal devices by insert molding, which is performed while the first and second internal devices are placed in a mold, wherein the holder holds the first and second internal devices such that the light output face and the light input face are opposite to each other with a gap interposed therebetween, the holder includes first and second resin walls in which the first and second sealing resin layers of the first and second internal devices are respectively embedded, the light output face is exposed from a first opening formed in the first resin wall and is planarly aligned with a surface of the first resin wall around the first opening, and the light input face is exposed from a second opening formed in the second resin wall and is planarly aligned with a surface of the second resin wall around the second opening.

### BRIEF DESCRIPTION OF THE SEVERAL VIEWS OF THE DRAWING

FIG. 1 is a sectional side view showing a photo-interrupter according to an embodiment of the present invention;

FIG. 2 is a perspective view of the photo-interrupter shown in FIG. 1;

FIG. 3 is a sectional view showing part of a mold used in a method of manufacturing the photo-interrupter shown in FIGS. 1 and 2, the view corresponding to the site where an internal device on the light-emitting side or light-receiving side is placed;

FIG. 4 is a perspective view showing a portion on the light-receiving side of a photo-interrupter according to a modification of the embodiment shown in FIG. 1;

FIG. 5 is a perspective view showing a portion on the light-receiving side of a photo-interrupter according to another modification of the embodiment shown in FIG. 1;

FIG. 6 is a perspective view showing a conventional photo-interrupter;

FIG. 7 is a perspective view showing a portion on the light-receiving side of another conventional photo-interrupter;

FIG. 8 is a sectional view showing part of a mold used in a method of manufacturing the photo-interrupter shown in FIG. 7, the view corresponding to the site where an internal device on the light-emitting side or light-receiving side is placed;

FIG. 9 is a sectional side view showing a still another conventional photo-interrupter; and

FIG. 10 is a sectional view showing part of a mold used in a method of manufacturing a photo-interrupter, the view corresponding to the site where an internal device on the light-emitting side or light-receiving side is placed, wherein this mold was studied in the process of developing the present invention.

### DETAILED DESCRIPTION OF THE INVENTION

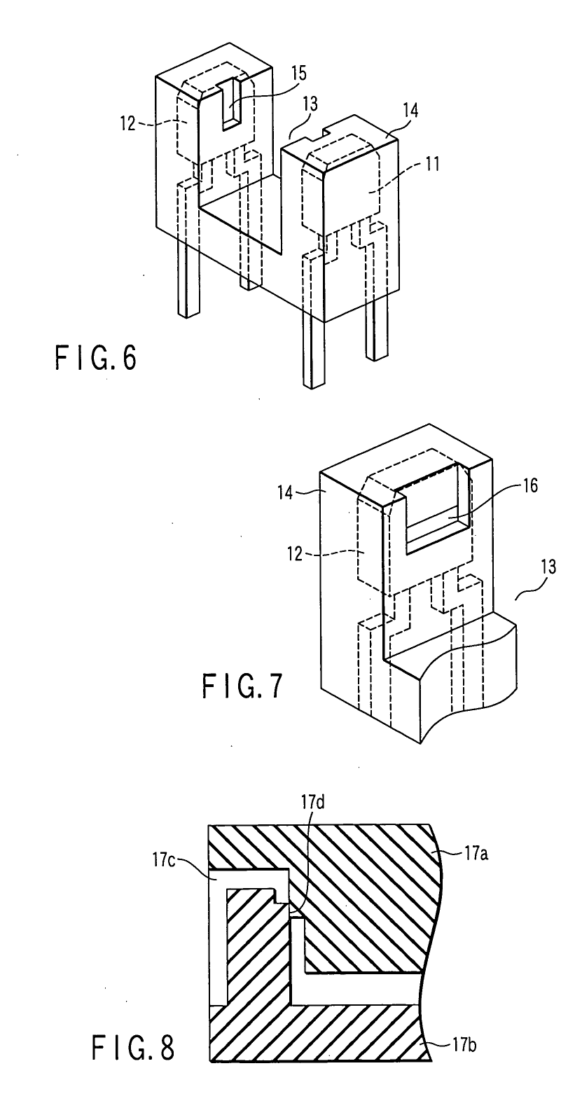

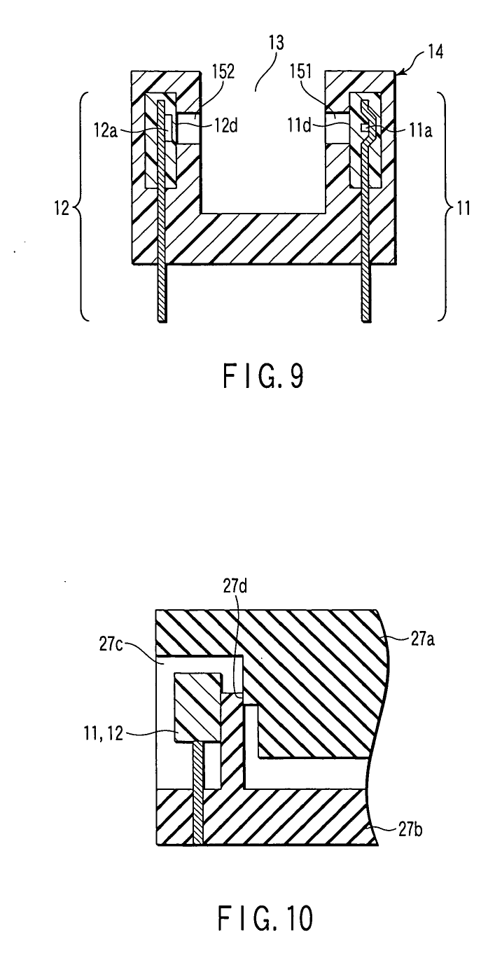

In the process of developing the present invention, the inventor studied the problems related to conventional photo-interrupters, as those shown in FIGS. 6 to 9. As a result, the inventor has arrived at the findings given below.

The photo-interrupters, as those shown in FIGS. 6 to 9, have slits 15, 16, 151, 152 each formed as a recess in a casing 14. Such a recessed slit also allows dust and particles to stay therein, thereby causing a decrease in detection sensitivity, and a malfunction. Furthermore, a light-emitting-side internal device 11 and a light-receiving-side internal device 12 are respectively inserted in upright portions on the light-emitting side and light-receiving side of a casing 14. This requires a step of assembling the photo-interrupter, which is disadvantageous in light of mass production.

The present inventor also studied how to form a casing 14 by insert molding, which is advantageous in light of mass production, and thus can reduce the cost. FIG. 10 is a sectional view showing part of a mold used in a method of manufacturing a photo-interrupter (shown in FIG. 7), the view corresponding to the site where an internal device on the light-emitting side or light-receiving side is placed. This mold was studied in the process of developing the present invention. As shown in FIG. 10, this mold 27 includes first and second portions 27a and 27b between which a bore 27c is defined to form the body of the casing 14. The slit 16 of the casing 14 is formed at a position 27d where the first and second portions 27a and 27b are in contact with each other. The site of the mold 27 where the other internal device is placed has a mirror image of the site shown in FIG. 10 with respect to the centerline therebetween.

In the mold 27 shown in FIG. 10, however, the shape of the second portion 27b is complicated. Furthermore, it is difficult to form a smaller casing 14 using mass production techniques, in light of the strength and accuracy of the mold. In addition, different molds for forming respective casings 14 need to be prepared, where the casings 14 differ in the shape of slits.

An embodiment of the present invention achieved on the basis of the findings given above will now be described with reference to the accompanying drawings. In the following description, the constituent elements having substantially the same function and arrangement are denoted by the same reference numerals, and a repetitive description will be made only when necessary.

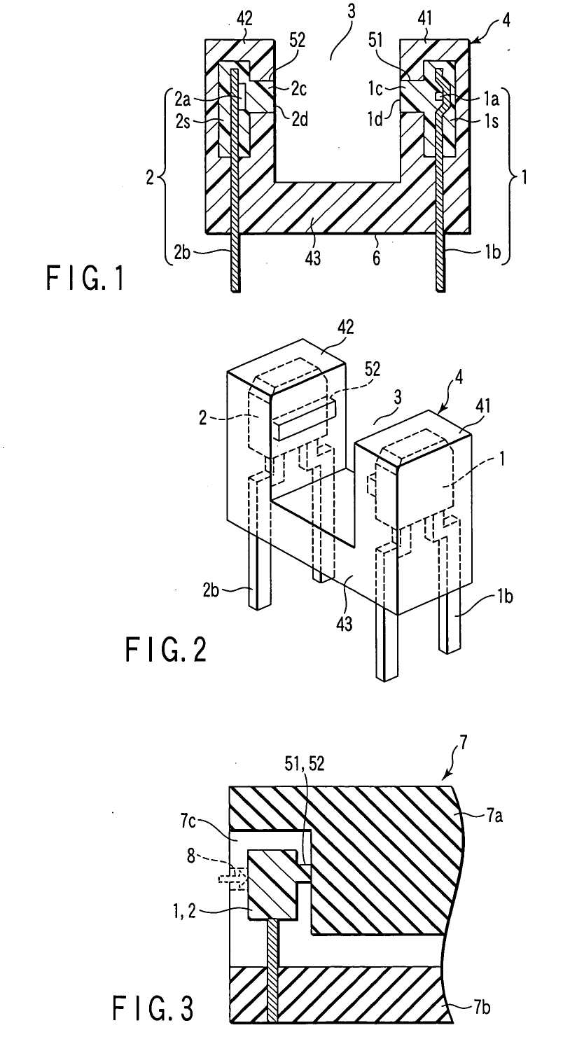

FIG. 1 is a sectional side view showing a photo-interrupter according to an embodiment of the present invention. FIG. 2 is a perspective view of the photo-interrupter shown in FIG. 1. As shown in FIGS. 1 and 2, a light-emitting-side internal device 1 and a light-receiving-side internal device 2 are held by a casing (holder) 4 to face each other with a predetermined gap 3 interposed therebetween.

The light-emitting-side internal device 1 includes a light-emitting chip la mounted on and connected to a lead frame 1b, and a sealing resin layer 1s formed by molding to seal the light-emitting chip 1a. The mount portion of the lead frame 1b is formed as a concave reflector to improve the light output efficiency from the light-emitting chip 1a. The sealing resin layer 1s has a projecting portion 1c formed of a part of the face opposite the gap 3 and projecting at a position corresponding to the light-emitting chip 1a. The distal end face of the projecting portion 1c functions as a light output face 1d to output light from the light-emitting chip 1a.

On the other hand, the light-receiving-side internal device 2 includes a light-receiving chip 2a mounted on and connected to a lead frame 2b, and a sealing resin layer 2s formed by molding to seal the light-receiving chip 2a. The sealing resin layer 2s has a projecting portion 2c formed of a part of the face opposite the gap 3 and projecting at a position corresponding to the light-receiving chip 2a. The distal end face of the projecting portion 2c functions as a light input face 2d to input light into the light-receiving chip 2a.

The casing 4 has a base 43, and a light-emitting-side wall 41 and a light-receiving-side wall 42 both standing on opposite sides of the base 43. The light-emitting-side wall 41, light-receiving-side wall 42, and base 43 consist of an integral body made of a thermo-plastic resin, which is formed by molding. More specifically, the casing 4 is formed by insert molding, i.e., by molding within a mold, in which the light-emitting-side internal device 1 and light-receiving-side internal device 2 are placed.

The light-emitting-side internal device 1 is held by the light-emitting-side wall 41, while the sealing resin layer 1s of the device 1 is embedded in the resin layer of the wall 41. The lead frame 1b of the light-emitting-side internal device 1 has two legs extending downward beyond the base 43 of the casing 4. Similarly, the light-receiving-side internal device 2 is held by the light-receiving-side wall 42, while the sealing resin layer 2s of the device 2 is embedded in the resin layer of the wall 42. The lead frame 2b of the light-receiving-side internal device 2 has two legs extending downward beyond the base 43 of the casing 4.

The light-emitting-side wall 41 and light-receiving-side wall 42 of the casing 4 are respectively provided with slits (openings) 51 and 52 formed therein at positions corresponding to the projecting portions 1c and 2c formed on the sealing resin layers 1s and 2s of the internal devices 1 and 2. The slits 51 and 52 are formed to have a longitudinal direction parallel with a mounting face 6 (bottom of the base 43) of the casing 4. The slits 51 and 52 are totally filled with the projecting portions 1c and 2c of the sealing resin layers 1s and 2s, respectively, thereby forming light guides.

The light output face 1d, which is the distal end face of the projecting portion 1c of the light-emitting-side internal device 1, is exposed to the gap 3 from the slit 51. The light output face 1d is flush with (i.e., planarly aligned with) the surface of the light-emitting-side wall 41 around the slit 51. Similarly, the light input face 2d, which is the distal end face of the projecting portion 2c of the light-receiving-side internal device 2, is exposed to the gap 3 from the slit 52. The light input face 2d is flush with (i.e., planarly aligned with) the surface of the light-receiving-side wall 42 around the slit 52.

Next, an explanation will be given of a method of manufacturing the photo-interrupter shown in FIGS. 1 and 2. In this method, a mold is used to form the casing 4 by insert molding. FIG. 3 is a sectional view showing part of a mold used in a method of manufacturing the photo-interrupter shown in FIGS. 1 and 2, the view corresponding to the site where an internal device on the light-emitting side or light-receiving side is placed. As shown in FIG. 3, this mold 7 includes first and second portions 7a and 7b between which a bore 7c is defined to form the body of the casing 4. The site of the mold 7 where the other internal device is placed has a mirror image of the site shown in FIG. 3 with respect to the centerline therebetween.

First, the light-emitting-side internal device 1 and light-receiving-side internal device 2 are formed as parts independent of each other. Specifically, the light-emitting chip la and light-receiving chip 2a are respectively mounted on the lead frames 1b and 2b having predetermined shapes. Then, the chips 1a and 2a are respectively electrically connected to the lead frames 1b and 2b.

Then, molding is performed on each of the chips 1a and 2a respectively connected to the lead frames 1b and 2b. With this operation, the light-emitting chip 1a is sealed by the sealing resin layer 1s. Also, the light-receiving chip 2a is sealed by the sealing resin layer 2s. At this time, the sealing resin layer 1s is provided with the projecting portion 1c formed thereon at a position corresponding to the light-emitting chip 1a, such that the distal end face of the projecting portion 1c is the light output face 1d. Similarly, the sealing resin layer 2s is provided with the projecting portion 2c formed thereon at a position corresponding to the light-receiving chip 2a, such that the distal end face of the projecting portion 2c is the light input face 2d.

Then, the light-emitting-side internal device 1 and light-receiving-side internal device 2 thus formed are placed in the mold 7 to prepare for insert molding. At this time, two internal devices 1 and 2 are placed in the mold 7 to have a positional relationship relative to each other shown in FIG. 1. An ejector pin 8 is used to press each of the internal devices 1 and 2 from behind against an inner surface of the mold 7. In other words, the light output face 1d and light input face 2d of the internal devices 1 and 2 are pressed against inner surfaces of the mold 7 toward the gap 3.

In this state, a thermo-plastic resin is supplied into the mold 7 to perform insert molding. As a consequence, the integral resin body of the casing 4 (holder) is formed to have the light-emitting-side wall 41, light-receiving-side wall 42, and base 43. At this time, the sealing resin layers 1s and 2s of the internal devices 1 and 2 are embedded in the resin layers of the light-emitting-side wall 41 and light-receiving-side wall 42, respectively. Also, the slits (openings) 51 and 52 are formed in the light-emitting-side wall 41 and light-receiving-side wall 42, at positions corresponding to the projecting portions 1c and 2c of the sealing resin layers is and 2s.

Then, the casing 4 is taken out of the mold 7, along with the light-emitting-side internal device 1 and light-receiving-side internal device 1. As a consequence, the photo-interrupter shown in FIGS. 1 and 2 is completed. Specifically, the light-emitting-side internal device 1 and a light-receiving-side internal device 2 are integratedly held by the casing 4 to face each other with the predetermined gap 3 interposed therebetween.

Next, an explanation will be given of an operation of the photo-interrupter shown in FIGS. 1 and 2. Specifically, an optical signal emitted from the light-emitting chip la of the light-emitting-side internal device 1 passes through the projecting portion 1c in the slit 51, and is outputted from the light output face 1d. The light thus outputted goes across the gap 3, and is inputted into the light input face 2d of the light-receiving-side internal device 2 on the opposite side. Then, the light passes through the projecting portion 2c in the slit 52, and is received by the light-receiving chip 2a. In this state, if an object passes through the gap 3, the optical signal received by the light-receiving chip 2a changes. In accordance with this principle, the photo-interrupter can be used as part of a sensor for detecting the position of an object in a non-contact manner.

In the photo-interrupter shown in FIGS. 1 and 2, the light output face 1d and light input face 2d of the internal devices 1 and 2 are exposed on flat surfaces on both sides of the gap 3. This arrangement prevents a problem of conventional photo-interrupters, i.e., dust and particles entering a recessed slit, and thereby improves the reliability and detection sensitivity. Furthermore, according to the manufacturing method described with reference to FIG. 3, since the slits of the casing 4 are formed by the projecting portions 1c and 2c of the internal devices 1 and 2, there is no need to prepare parts for forming the slit in the mold 7. As a consequence, the photo-interrupter is made compact, and mass production thereof can be realized by insert molding. In addition, the same mold can be used to form casings 4 different in the shape of slits.

In the photo-interrupter shown in FIGS. 1 and 2, the slits 51 and 52 are formed to have a longitudinal direction parallel with the mounting face 6 (bottom of the base 43) of the casing 4. However, the shape and size of the slits 51 and 52 can be changed in accordance with conditions, such as required sensitivity, by changing the shape of the projecting portions 1c and 2c of the internal devices 1 and 2.

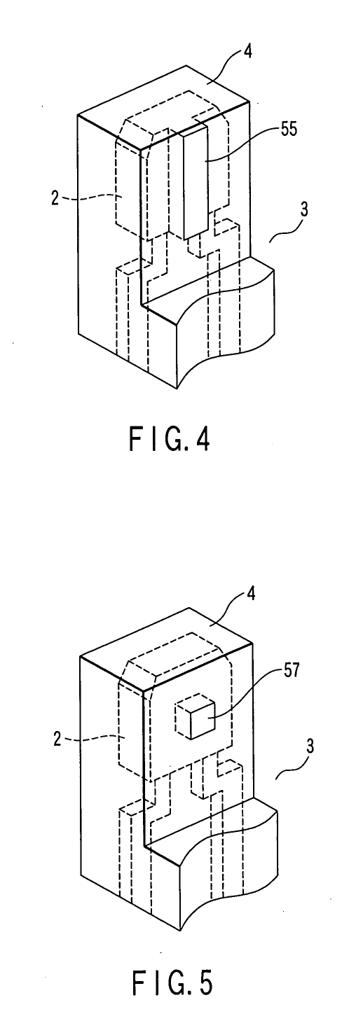

FIGS. 4 and 5 are perspective views each showing a portion on the light-receiving side of a photo-interrupter according to one of two modifications of the embodiment shown in FIG. 1. The photo-interrupter shown in FIG. 4 has a slit 55 formed to have a longitudinal direction perpendicular to the mounting face 6 (bottom of the base 43: see FIG. 1) of the casing 4. The photo-interrupter shown in FIG. 5 has a slit 57 formed in a small square shape.

The slit shapes of the light-emitting side and light-receiving side are not necessarily the same. The light output face 1d and light input face 2d of the internal devices 1 and 2 are not necessarily formed of the distal end faces of projecting portions. For example, the internal devices 1 and 2 may have sealing resin layers 1s and 2s formed by molding, whose faces opposite the gap 3 are entirely flat, so that the entire faces respectively function as light output face and light input face.

The casing 4 is not necessarily formed by insert molding, as long as the light output face 1d and light input face 2d of the internal devices are exposed on flat surfaces on both sides of the gap 3. For example, the casing 4 may be formed by transfer molding with a thermosetting resin, or by casting with a liquid resin or the like.

Furthermore, a HOOP line may be used to perform manufacturing steps. In this case, the lead frames on the light-emitting side and light-receiving side are formed of HOOP frames. Then, chips are mounted on and connected to the lead frames, and are subjected to molding. Then, the devices on the light-emitting side and light-receiving side thus formed are placed to face each other, and are subjected to insert molding by a HOOP line. Then, photo-interrupters thus formed are separated one by one. A HOOP line thus used can improve the productivity and reduce the cost.

As described above, the photo-interrupter can be used as part of a sensor for detecting the position of an object in a non-contact manner. A sensor of this type is utilized in various apparatuses, such as a facsimile machine, copying machine, image scanner, fan heater, VTR, vending machine, and ticket-vending machine, as well as a printer and DSC.

According to an embodiment and modifications thereof described above, there is provided a photo-interrupter and manufacturing method thereof, which allow high sensitivity, high reliability, small size, and mass production of a photo-interrupter.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A photo-interrupter comprising:
a light-emitting-side internal device provided with a light-emitting chip and formed by molding, the light-emitting-side internal device having a light output face;
a light-receiving-side internal device provided with a light-receiving chip and formed by molding, the light-receiving-side internal device having a light input face; and
a casing that holds the light-emitting-side internal device and the light-receiving-side internal device such that the light output face and the light input face are opposite to each other with a gap interposed therebetween, the light output face and the light input face are respectively disposed in first and second slits formed in the casing, and the light output face and the light input face are respectively flush with surfaces of the casing around the first and second slits.

2. The photo-interrupter according to claim 1, wherein the first and second slits form a light guide.

3. The photo-interrupter according to claim 1, wherein the light output face is defined by a distal end face of a projecting portion formed on the light-emitting-side internal device.

4. The photo-interrupter according to claim 1, wherein the light input face is defined by a distal end face of a projecting portion formed on the light-receiving-side internal device.

5. The photo-interrupter according to claim 1, wherein the casing comprises first and second resin portions respectively surrounding the light-emitting-side internal-device and the light-receiving-side internal device, and the first and second slits are respectively formed in the first and second resin portions.

6. The photo-interrupter according to claim 5, wherein the casing is formed by insert molding, which is performed while the light-emitting-side internal device and the light-receiving-side internal device are placed in a mold.

7. The photo-interrupter according to claim 1, wherein the first and second slits have a longitudinal direction parallel with or perpendicular to a mounting face of the casing.

8. A method of manufacturing a photo-interrupter, the method comprising:
mounting and connecting a light-emitting chip and a light-receiving chip onto respective lead frames;
performing molding on the light-emitting chip and the light-receiving chip connected to the lead frames, to form a light-emitting-side internal device and a light-receiving-side internal device, such that the light-emitting-side internal device has a light output face, and the light-receiving-side internal device has a light input face; and
attaching the light-emitting-side internal device and the light-receiving-side internal device to a casing such that the light output face and the light input face are opposite to each other with a gap interposed therebetween, the light output face and the light input face are respectively disposed in first and second slits formed in the casing, and the light output face and the light input face are respectively flush with surfaces of the casing around the first and second slits.

9. The method according to claim 8, further comprising forming the casing by insert molding, which is performed while the light-emitting-side internal device and the light-receiving-side internal device are placed in a mold.

10. The method according to claim 9, wherein the insert molding is performed while the light output face and the light input face are pressed against inner surfaces of the mold.

11. A photo-interrupter comprising:
a first internal device including a light-emitting chip, a first lead connected to the light-emitting chip, and a first sealing resin layer sealing the light-emitting chip and having a light output face;
a second internal device including a light-receiving chip, a second lead connected to the light-receiving chip, and a second sealing resin layer sealing the light-receiving chip and having a light input face; and
a holder holding the first and second internal devices such that the light output face and the light input face are opposite to each other with a gap interposed therebetween, the holder includes first and second resin walls in which the first and second sealing resin layers of the first and second internal devices are respectively embedded, the light output face is exposed from a first opening formed in the first resin wall and is planarly aligned with a surface of the first resin wall around the first opening, and the light input face is exposed from a second opening formed in the second resin wall and is planarly aligned with a surface of the second resin wall around the second opening.

12. The photo-interrupter according to claim 11, wherein the first sealing resin layer includes a projecting portion formed of a part of a face opposite the gap and projecting therefrom, and the light output face is defined by a distal end face of the projecting portion.

13. The photo-interrupter according to claim 11, wherein the second sealing resin layer includes a projecting portion formed of a part of a face opposite the gap and projecting therefrom, and the light input face is defined by a distal end face of the projecting portion.

14. A method of manufacturing a photo-interrupter, the method comprising:
electrically connecting a light-emitting chip and a light-receiving chip to first and second leads, respectively;
performing molding on the light-emitting chip and the light-receiving chip respectively connected to the first and second leads, to form first and second internal devices, such that the first internal device includes a first sealing resin layer sealing the light-emitting chip and having a light output face, and the second internal device includes a second sealing resin layer sealing the light-receiving chip and having a light input face; and
forming a holder holding the first and second internal devices by insert molding, which is performed while the first and second internal devices are placed in a mold, wherein the holder holds the first and second internal devices such that the light output face and the light input face are opposite to each other with a gap interposed therebetween, the holder includes first and second resin walls in which the first and second sealing resin layers of the first and second internal devices are respectively embedded, the light output face is exposed from a first opening formed in the first resin wall and is planarly aligned with a surface of the first resin wall around the first opening, and the light input face is exposed from a second opening formed in the second resin wall and is planarly aligned with a surface of the second resin wall around the second opening.

15. The method according to claim 14, wherein the insert molding is performed while the light output face and the light input face are pressed against inner surfaces of the mold.
